(19) United States
(12) Patent Application Publication
(10) Pub. No.: US 2026/0325262 A1
(43) Pub. Date: Oct. 22, 2026

(54) DENTAL IMPLANT ASSEMBLY

(71) Applicants: Doron BAR-CHEN, Netanya (IL); Omer KOTON, Tel-Aviv Yaffo (IL)

(72) Inventors: Doron BAR-CHEN, Netanya (IL); Omer KOTON, Tel-Aviv Yaffo (IL)

(21) Appl. No.: 19/110,455

(22) PCT Filed: Aug. 29, 2023
(86) PCT No.: PCT/IL2023/050918

§ 371 Date: Mar. 11, 2025

(30) Foreign Application Priority Data
Sep. 11, 2022 (IL) 296381

(51) Int. Cl. A61C 8/00

(52) U.S. Cl. CPC A61C 8/0022; A61C 8/0037; A61C 8/005

(57) ABSTRACT

The invention relates to a dental implant for the elimination of peri-implantitis, comprising a body comprising a lower portion comprising a first connector and one or more upper portions; each upper portion comprising a second connector configured to connect with the first connector, and a third connector located an opposite side of the second connector; where said first connector is geometrically similar or identical to the third connector.

### RELATED APPLICATION/S

This application claims the benefit of priority of Israel Patent Application No. 296381 filed on 11 Sep. 2022, the contents of which are incorporated herein by reference in their entirety.

### FIELD AND BACKGROUND OF THE INVENTION

The present invention, in some embodiments thereof, relates to a dental implant assembly and, more particularly, but not exclusively, to a dental implant assembly for the elimination of peri-implantitis.

Usually, the body of an implant is made of titanium, which does not create an immune reaction by the body. In the manufacturing process of an implant, the implant surface is processed by burning with acid and spraying with particles (roughening), in order to improve, optimize and accelerate its absorption in the bone. This process is called oseointegration.

The oral cavity and the implant environment are constantly contaminated with bacteria and bacterial byproducts. As long as the entire body of the implant remains surrounded by bone, no inflammatory process happens. But, once an inflammatory process or conventional gum disease begins in the surrounding of the implant, the implant body, which as mentioned has undergone a roughening process, becomes a “habitat” for bacteria and their products (endotoxins). As a result, the gum disease around the implant is increased, and accelerates the absorption of the supporting bone.

In other words, the advantage of a rough surface of an implant upon being inserted into a bone becomes a disadvantage when the implant begins to be exposed to oral cavity. This whole process and the gum disease that develops around the implant—is called Peri-implantitis.

It is almost impossible to “disinfect” an implant surface exposed to the mouth. Furthermore, after attempting to preserve an old implant with various treatments, the implant has to be removed and replaced by a new implant.

The term “Peri-implantitis is defined in Wikipedia as follows:

“Peri-implantitis is a destructive inflammatory process affecting the soft and hard tissues surrounding dental implants. The soft tissues become inflamed whereas the alveolar bone (hard tissue), which surrounds the implant for the purposes of retention, is lost over time. (From Wikipedia, Peri-implantitis)”.

Additional background art includes U.S. Patent Application No. US20120156645A1 disclosing a system, method and device design to prevent, treat and maintain dental peri-implant infections including a dental implant to be inserted into a jawbone of a patient that includes a base segment provided at one distal end of the implant which is configured to be put inside and come in contact with the jawbone, an abutment portion provided on an end opposite to the one distal end of the implant to which an artificial tooth is configured to be attached, and a plurality of removable segments which are configured to be put inside and come in contact with the jawbone and are removably attached to the base segment. If an infection is diagnosed around an implant site, infected removable segments can be extracted while maintaining positioning of the uninfected removable segments and the base segment. The infected removable segments are replaced with cleaned or sterilized removable segments.

U.S. Patent Application No. US20150157426A1 disclosing a dental implant, in which a fixture and an abutment are together by a separate screw post so as to prevent a breakage of an implant screw tightening part and uniformly transmit forces over the entirety of a contact surface, to prevent stresses from being partially concentrated, and in which the screw-tightening direction between the fixture and the abutment is variable so as to improve the coupling force between them and fundamentally prevent a screw from becoming loosened. The dental implant includes a fixture and abutment, an abutment including a lower abutment to be fitted onto the fixture, and an upper abutment connected to an upper portion of the lower abutment, the lower abutment and the upper abutment being separate from each other. The upper abutment and the fixture are coupled and fixed by the screw post.

European Patent Application No. EP3219288A1 disclosing an osseointegrated dental crown, comprising an endosseous fixture and an abutment connected by means of a fixture connection and fixed by means of a fixing screw, where the abutment comprises an insertion projection of prismatic shape having a lower end provided with a prismatic seat, and the fixture comprises a prismatic cavity of corresponding and complementary shape to the insertion projection of the abutment and a protrusion projecting in the prismatic cavity and of corresponding and complementary shape to the prismatic seat of the abutment, in that the endosseous fixture has an annular external top edge of the prismatic cavity and a vertical central threaded hole extending from the protrusion, while the abutment has an annular external shoulder at the base of the insertion projection and a vertical central through hole, coaxial with respect to the threaded hole, in that the top edge of the prismatic cavity and the shoulder of the insertion projection are juxtaposed at a contact plane between abutment and fixture, and in that the fixing screw is engaged, with the stem, by screwing in the threaded hole, is inserted, with the related head part, in the through hole, and produces the stable coupling of the abutment and of the endosseous fixture, the head being arranged substantially at the contact plane.

U.S. Patent Application No. US20190099243A1 disclosing a dental implant system for bone regeneration of a bone defect site of a jawbone including an implant which is to be anchored in the jawbone, a film for covering over the bone defect site and the implant, a spacer element which in a fitted position of the dental implant system is to be arranged between the implant and the film, and an abutment, where the film in the fitted position is to be clamped between the spacer element and the abutment, where in the fitted position the spacer element and the abutment are connected by means of a form-locked connection.

International Patent Application Publication No. WO2013186764A1 disclosing an abutment system that is comprised of an implant anchor with a socket located at the attachment end of the implant anchor, an annular protrusion located inside the implant cavity and below the socket, and an abutment having a connector located at the attachment end of the abutment. The connector is configured to be fitted into the socket of said implant anchor. Said connector is comprised of at least two bendable sections separated from each other by a slot and an annular groove located on the outer surface of the connector end. The annular protrusion of the implant anchor is configured to be fitted into the annular groove of the connector thus forming a snap connection between said implant anchor and the abutment.

### SUMMARY OF THE INVENTION

Following is a non-exclusive list including some examples of embodiments of the invention. The invention also includes embodiments which include fewer than all the features in an example and embodiments using features from multiple examples, also if not expressly listed below.

Example 1. A dental implant for the elimination of peri-implantitis, comprising a body comprising a proximal end and a distal end, said body comprising:

a. a lower portion located at said distal end of said body; said lower portion comprising a first first type of connector at a proximal end of said lower portion; and

b. one or more upper portions located at said proximal end of said body; each upper portion of said one or more upper portions comprising:

i. a first second type of connector located at a distal end of said upper portion and configured to connect with said first first type of connector; and

ii. a second first first type of connector located a proximal end of said upper portion;
wherein said first first type of connector is geometrically similar or identical to said second first first type of connector.

Example 2. The dental implant according to example 1, wherein said dental implant comprises only one upper part.

Example 3. The dental implant according to example 1 or example 2, wherein said first type of connector is a female type connector.

Example 4. The dental implant according to any one of examples 1-3, wherein said second type of connector is a male type connector.

Example 5. The dental implant according to any one of examples 1-4, wherein said first type of connector and said second first first type of connector are both configured to be coupled to an abutment.

Example 6. The dental implant according to any one of examples 1-5, wherein said abutment comprises a second type of connector that is configured to be coupled to said first type of connector and said second first first type of connector.

Example 7. The dental implant according to any one of examples 1-6, wherein said body comprises an internal channel configured to receive a securing rod; said securing rod configured to secure said lower portion and said one or more upper portions.

Example 8. The dental implant according to any one of examples 1-7, wherein said body comprises a threaded portion extending from said distal end to said proximal end.

Example 9. The dental implant according to any one of examples 1-8, wherein said lower portion comprises a distal end having a conical or narrowing form and a proximal end having a cylindrical continuous form.

Example 10. The dental implant according to any one of examples 1-9, wherein said one or more upper parts have a same cylindrical continuous form as said proximal end of said lower portion.

Example 11. The dental implant according to any one of examples 1-10, wherein when said lower portion is connected to one upper part of said one or more upper parts it generates a continuous surface having said cylindrical continuous form.

Example 12. The dental implant according to any one of examples 1-11, wherein said lower portion comprises a switching platform feature at a most proximal end of said lower portion.

Example 13. The dental implant according to any one of examples 1-12, wherein each of said one or more upper portions comprise a switching platform feature at a most proximal end of said one or more upper portions.

Example 14. The dental implant according to any one of examples 1-13, wherein when said lower portion is connected to one upper part of said one or more upper parts it comprises an indentation at the area where said lower portion and said one or more upper parts meet; said indentation generated by said switching platform feature.

Example 15. The dental implant according to any one of examples 1-14, wherein said lower portion is a shorter version of said dental implant.

Example 16. The dental implant according to any one of examples 1-15, wherein a total length of said dental implant is from about 4 mm to 20 mm.

Example 17. The dental implant according to any one of examples 1-16, wherein a diameter of said dental implant is from about 2 mm to 10 mm.

Example 18. The dental implant according to any one of examples 1-17, wherein a length of said lower portion is from about 6 mm to about 8 mm.

Example 19. The dental implant according to any one of examples 1-18, wherein a length of said upper portion is from about 5 mm to about 10 mm.

Example 20. A method of eliminating peri-implantitis in a location where a dental implant is located, comprising:
a. identifying the presence of peri-implantitis;
b. removing an upper part of said implant.

Example 21. The method according to example 20, wherein said dental implant is a dental implant according to example 1.

Example 22. The method according to example 20 or example 21, wherein said identifying comprises identifying loss of bone around an area where said upper part of said dental implant is located.

Example 23. The method according to any one of examples 20-22, further comprising removing an abutment from said upper part of said implant before said removing said upper part of said implant.

Example 24. The method according to any one of examples 20-23, further comprising removing a crown from said abutment before said removing said abutment.

Example 25. The method according to any one of examples 20-24, further comprising reconnecting said abutment to a lower part of said implant.

Example 26. The method according to any one of examples 20-25, further comprising reconnecting a crown to said abutment after said reconnecting said abutment.

Example 27. The method according to any one of examples 20-26, further comprising connecting a new upper portion to said implant before reconnecting said abutment.

Example 28. The method according to any one of examples 20-27, further comprising connecting a new abutment to said implant; said new abutment having a total length consisting of the sum of a length of said removed upper part of said implant and a length of said removed abutment.

Example 29. A dental system, comprising:
a. a dental implant according to example 1,
b. an abutment; and
c. a connecting rod.

Example 29a. The dental system according to example 29, further comprising a crown.

Example 30. A method of speeding up healing in a location where peri-implantitis has been identified, comprising:
a. identifying the presence of peri-implantitis;
b. removing an upper part of said implant.

Example 31. The method according to example 30, wherein said dental implant is a dental implant according to claim 1.

Example 32. The method according to example 30 or example 31, wherein said identifying comprises identifying loss of bone around an area where said upper part of said dental implant is located.

Example 33. The method according to any one of examples 30-32, further comprising removing an abutment from said upper part of said implant before said removing said upper part of said implant.

Example 34. The method according to any one of examples 30-33, further comprising removing a crown from said abutment before said removing said abutment.

Example 35. The method according to any one of examples 30-34, further comprising reconnecting said abutment to a lower part of said implant.

Example 36. The method according to any one of examples 30-35, further comprising reconnecting a crown to said abutment after said reconnecting said abutment.

Example 37. The method according to any one of examples 30-36, further comprising connecting a new upper portion to said implant before reconnecting said abutment.

Example 38. The method according to any one of examples 30-37, further comprising connecting a new abutment to said implant; said new abutment having a total length consisting of the sum of a length of said removed upper part of said implant and a length of said removed abutment.

Example 39. A method of eliminating peri-implantitis in a location where a dental implant is located, comprising:

a. identifying the presence of peri-implantitis;

b. removing an upper part of said implant.

Example 40. The method according to example 39, wherein said dental implant is a dental implant according to claim 1.

Example 41. The method according to example 39 or example 40, wherein said identifying comprises identifying loss of bone around an area where said upper part of said dental implant is located.

Example 42. The method according to any one of examples 39-41, further comprising removing an abutment from said upper part of said implant before said removing said upper part of said implant.

Example 43. The method according to any one of examples 39-42, further comprising removing a crown from said abutment before said removing said abutment.

Example 44. The method according to any one of examples 39-43, further comprising reconnecting said abutment to a lower part of said implant.

Example 45. The method according to any one of examples 39-44, further comprising reconnecting a crown to said abutment after said reconnecting said abutment.

Example 46. The method according to any one of examples 39-45, further comprising connecting a new upper portion to said implant before reconnecting said abutment.

Example 47. The method according to any one of examples 39-46, further comprising connecting a new abutment to said implant; said new abutment having a total length consisting of the sum of a length of said removed upper part of said implant and a length of said removed abutment.

In one aspect, the present invention is directed to a dental implant assembly, comprising: an implant having an external threading, wherein the implant is composed of at least two detachable parts connected to each other; an abutment fixed to at least one of the at least two parts; and a crown fixed to the abutment.

According to one embodiment of the invention, in each two adjacent parts of the implant, one comprises a pyramided form male member, and other comprises a pyramided form female member, respectively to each other.

According to one embodiment of the invention, the implant parts are connected to each other by a threaded rod.

According to one embodiment of the invention, the implant parts and the abutment are connected to each other by a threaded rod.

According to one embodiment of the invention, the implant parts, the abutment, and the crown are connected to each other by a threaded rod.

According to one embodiment of the invention, the threaded rod comprises an inner nut form, for threading thereof.

According to one embodiment of the invention, the threaded rod comprises external nut form (known in the art as nut head, Bolt fastener), for threading thereof.

According to one embodiment of the invention, the implant parts are connected to each other.

According to one embodiment of the invention, the implant parts are connected to each other by a snap connection.

Preferably, the connection between the abutment and the replaceable part of the implant is in a form of a polygonal prism. More particularly, the male part of the connection is in a prismatic polygonal form and the female part of the connection corresponds to this form.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERA VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

Figures 1a-c are schematic representations of a dental implant according to the prior art;

FIGS. 2a-i are schematic representations of an exemplary dental assembly, according to some embodiments of the invention;

FIGS. 3a-f are schematic representations of an exemplary dental implant assembly, according to some embodiments of the invention;

FIGS. 4a-c are schematic representations of an exemplary peri-implantitis process;

FIG. 5 is a flowchart of an exemplary method of eliminating peri-implantitis, according to some embodiments of the invention;

FIGS. 6a-m are schematic representations of the exemplary methods, according to some embodiments of the invention;

FIGS. 7a-f are schematic representations of exemplary dental implant assembly used in dental bridges, according to some embodiments of the invention;

FIGS. 8a-f are schematic representation of exemplary dental implant assemblies comprising switching platform features, according to some embodiments of the invention.

### DESCRIPTION OF SPECIFIC EMBODIMENTS OF THE INVENTION

The present invention, in some embodiments thereof, relates to a dental implant assembly and, more particularly, but not exclusively, to a dental implant assembly for the elimination of peri-implantitis.

### Overview

An aspect of some embodiments of the invention related to eliminating peri-implantitis in a patient. In some embodiments, elimination of peri-implantitis is performed by removing at least a part or portion of a dental implant. In some embodiments, the part or portion of the dental implant that is removed is a part or portion of the implant that is located in the area where peri-implantitis is found and/or is the part or portion of the dental implant causing peri-implantitis. In some embodiments, the part or portion of the dental implant that is removed is a part or portion of the implant that is located adjacent or distally to an abutment (or any other relevant dental part connected proximally to the dental implant) connected to the dental implant. In some embodiments, removing a part or portion of the dental implant comprises removing an upper part of the dental implant while leaving a lower part or portion of the dental implant in the location where the dental implant is implanted. In some embodiments, removing the part or portion of the dental implant is the action that eliminates the peri-implantitis. In some embodiments, the part or portion that is left implanted (the lower part of the dental implant) is configured to receive the abutment (or any other relevant dental part) that was connected to the part or portion of the dental implant that was removed or configured to receive a new abutment which comprises a length of the part of the dental implant that was removed and the length of the previously attached abutment. In some embodiments, a new abutment is connected to the lower part or portion that is left implanted from the dental implant. In some embodiments, a new abutment comprises a total length consisting of the length of the upper part or portion that was removed and the length of the abutment that was previously connected. In some embodiments, a new upper part or portion of an implant is attached to the lower part or portion of the implant that is left implanted, to replace the previous upper part or portion that was removed.

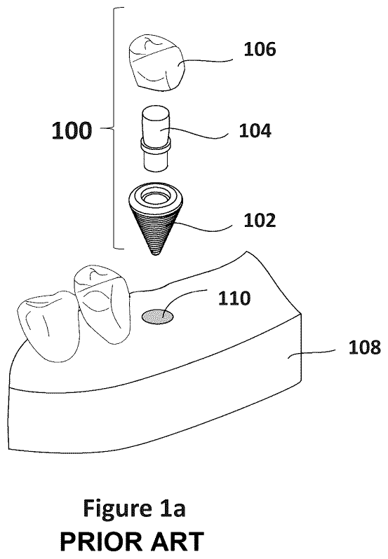

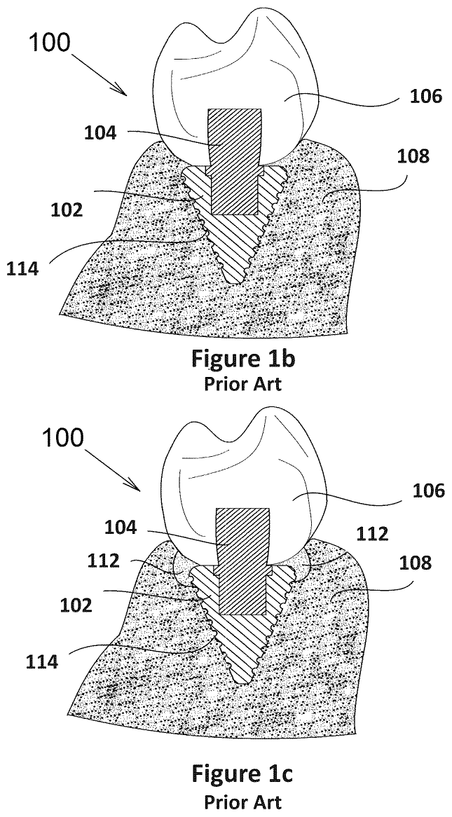

For purposes of better understanding some embodiments of the present invention, as illustrated in FIGS. 1a-c of the drawings, reference is first made to the construction and operation of a dental implant 100, according to the prior art.

Referring now to FIG. 1a showing an exploded view of a dental implant 100, according to the prior art. An implant assembly, which is marked by reference numeral 100, comprises an implant body 102 which has an external threading, an abutment 104, and a crown 106 which resembles the tooth it replaces. The abutment 104 is connected to the implant body 102, for example by a threaded rod, and other. Reference numeral 108 denotes a bone such as a mandible bone and a maxilla bone. And reference numeral 110 denotes a space in bone 108 into which the implant body 102 is fixed. Each of FIGS. 1b and 1c is a longitudinal cross-section of a bone 108 (e.g., a mandible bone) in which is implanted an implant assembly 100, according to the prior art. The implant assembly 100 comprises an implant body 102, an abutment 104 fixed in the implant body 102, and a crown 106 in which the abutment 104 is fixed. The implant body has an external threading. In FIG. 1b, the implant body 102 is implanted in a “healthy” tissue, i.e., not infected by Peri-implantitis. In FIG. 1c there is a Peri-implantitis inflammatory tissue 112, which develops around the implant 102, near to the crown 106. As the time goes by, the inflammatory zone expands. The threading 114 of the implant body 102 is habitat for bacteria, and therefore after several years the tissue that surrounds the implant becomes inflammatory, i.e., infected by Peri-implantitis. As a result, the grabbing of the implant assembly by the bone weakens. Cleaning the infected part of the implant from the bacteria is almost impossible. Therefore sometimes the dental implant assembly has to be replaced by a new dental implant, which is a complicated and costly process.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

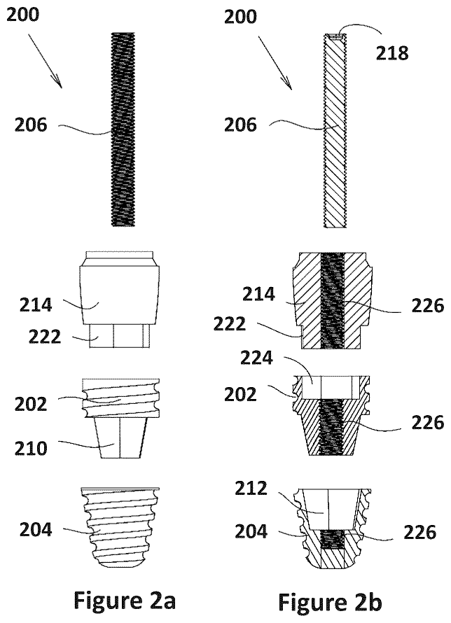

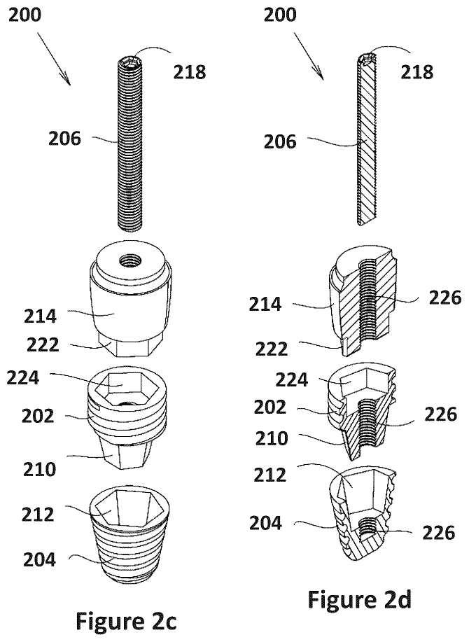

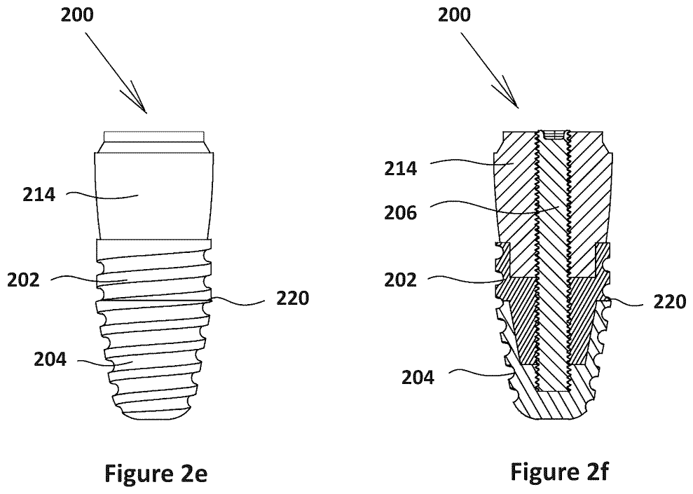

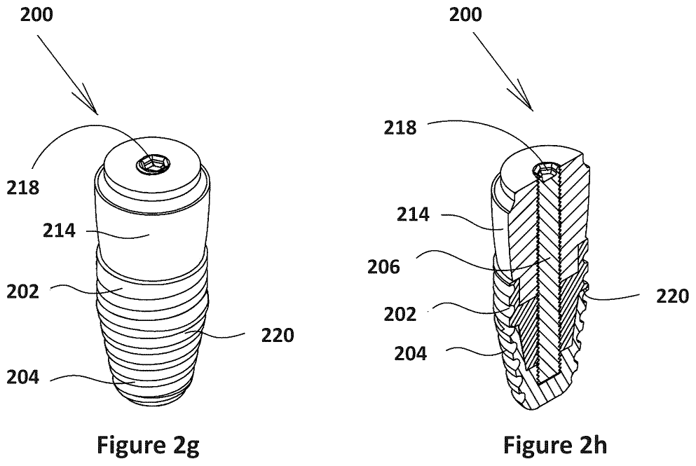

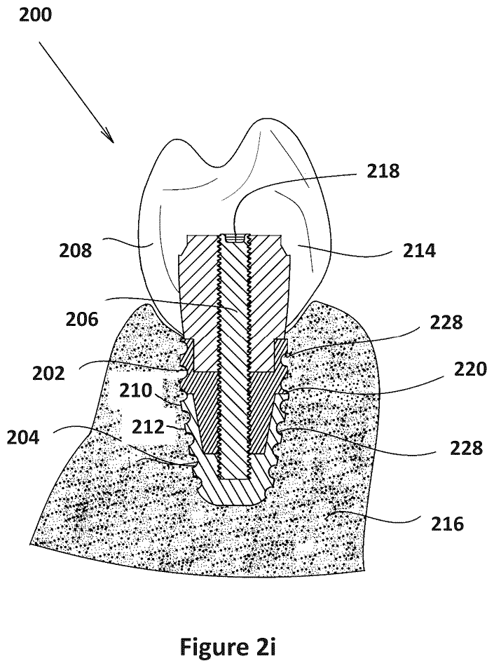

Referring now to FIGS. 2a-i, showing schematic representations of an exemplary dental assembly, according to some embodiments of the invention. FIG. 2a is a side-exploded view of a dental implant assembly 200, according to some embodiments of the invention, while FIG. 2b is a central longitudinal cross-section thereof at the symmetry line.

FIG. 2c is a perspective exploded view of a dental implant assembly 200, according to one embodiment of the invention, while FIG. 2d is a central longitudinal cross-section thereof at the symmetry line.

The crown is not shown in FIGS. 2a-d.

In some embodiments, the dental implant is composed of two parts 202 and 204, to be fastened to each other by, for example, by a threaded rod 206, snap connection, etc. Part 202 is the closer to the crown 208, and part 204 is the farther to the crown 208 (as shown inter alia in FIG. 2i). In some embodiments, threaded rod 206 comprises a nut form 218 of at one edge of the threaded rod 206, for threading the threaded rod 206. In some embodiments, the parts of the implant 200 comprise an internal threaded portion 226 configured for receiving the threaded rod 206.

Since the Peri-implantitis begins to develop around the closer part of the implant to the crown, i.e., 202, if replacement of the implant is required, instead of replacing the entire implant, only this part can be replaced. Replacing this part (i.e., 202) does not require a complicated and costly process as replacing the entire implant.

The connection between the two parts of the implant is pyramidal, meaning that one part of the implant has a male pyramid shape 210, and the part connected to it has a female pyramid shape 212. This structure provides two advantages: threading the two parts of the implant together as if they were one part, and quick release of the part of the implant for replacement.

The threaded rod 206 can connect both parts 202 and 204 of the implant, the abutment 214, and even the crown. In some embodiments, the abutment 214 comprises a male polygonal prism part of a connector 222, while the upper part 202 comprises a female polygonal prism part of a connector 224, configured to receive the male polygonal prism part of a connector 222.

When implanting the implant, a bore is drilled into the bone. The diameter of the bone is slightly smaller than the diameter of the implant. Over time the bone covers the threading of the implant, so after a few months the implant is fixed into the bone.

It should be noted that the connection between the abutment 214 and the replaceable part 202 of the dental implant is in a form of a polygonal prism. This allows placing the abutment 214 in the same orientation with reference to the dental implant as in the original form, and also retains this orientation later on.

FIG. 2e is a side view of an implanted dental implant assembly 200, according to some embodiments of the invention, while FIG. 2f is a central longitudinal cross-section thereof at the symmetry line. FIG. 2g is a perspective view of an implanted dental implant assembly 200, according to one embodiment of the invention, while FIG. 2h is a central longitudinal cross-section thereof at the symmetry line.

As shown, parts 202 and 204 of the implant are composed together. From functional point of view, the two-parts implant of the present invention operate as a prior art implant, except that part 202 can be removed, thereby sparing the need of replacing the entire implant. FIGS. 2e-h and also FIG. 2i below, show a seam line 220 between two adjacent parts of a dental implant.

It should be noted that according to embodiments of the present invention, an implant can be composed by more than two parts.

The crown 208 is not shown in these figures.

FIG. 2i is a longitudinal cross-section of a bone in which is fixed a dental implant assembly 200, according to one embodiment of the invention.

The dental implant assembly 200 comprises a dental implant composed of two detachable parts 202 and 204. In some embodiments, the dental implant assembly 200 comprises an external threading 228. Reference numeral 216 denotes a bone, such as the maxilla and the mandible bone. In the bone is implanted the implant which comprises two parts 202 and 204. An abutment 214 is attached to part 202 of the implant. In this example, a threaded rod 206 attaches to each other parts 202 and 204 of the dental implant, and the abutment 214 to which a crown 208 is attached.

According to one embodiment of the invention (not illustrated), the threaded rod 206 connects not only the parts 202 and 204 of the implant and the abutment 214, but also the crown 208.

As mentioned, this technology saves the need to remove the entire existing implant and perform the implantation process from the beginning, thus potentially avoiding the potential surgical complications, extra time, and extra costs.

In the examples herein the implants according to the present invention comprise only two parts, 202 and 204. However, it should be noted that an implant according to the present invention may comprise more than two parts.

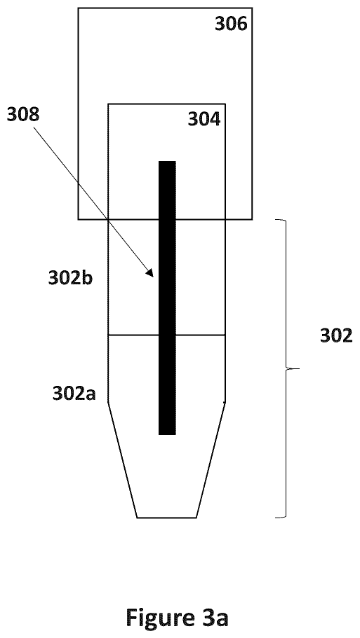

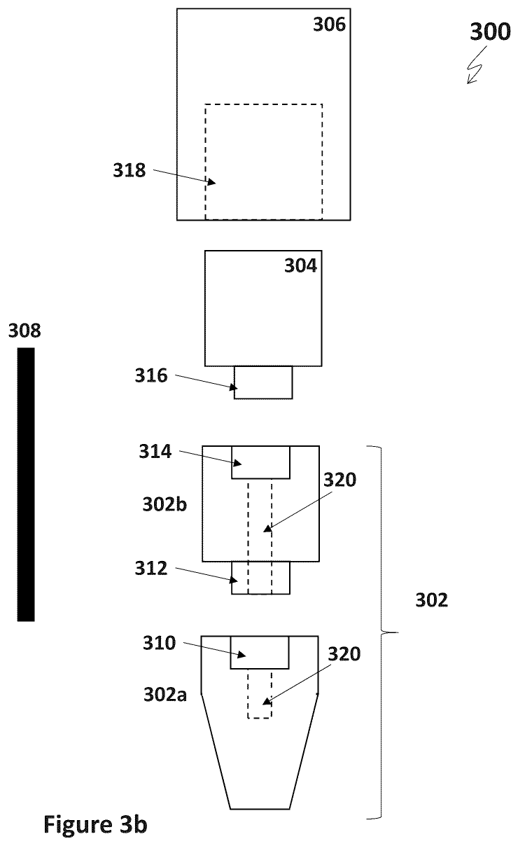

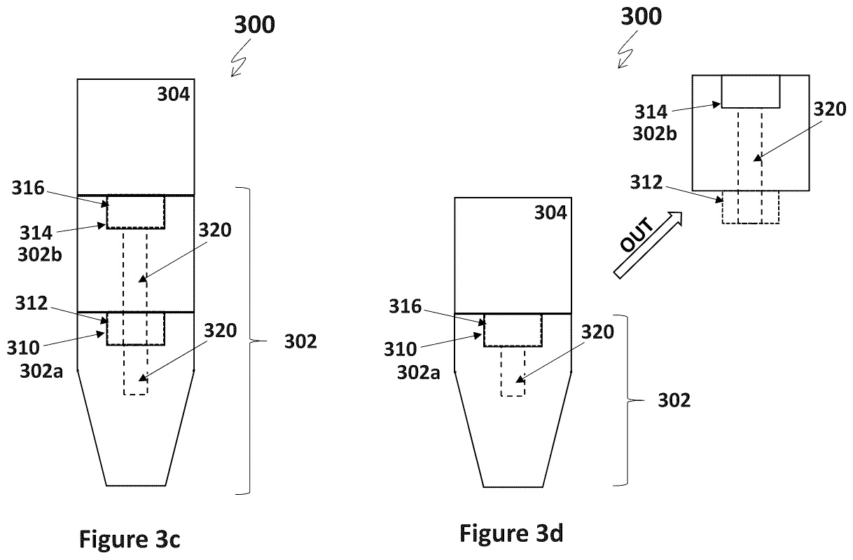

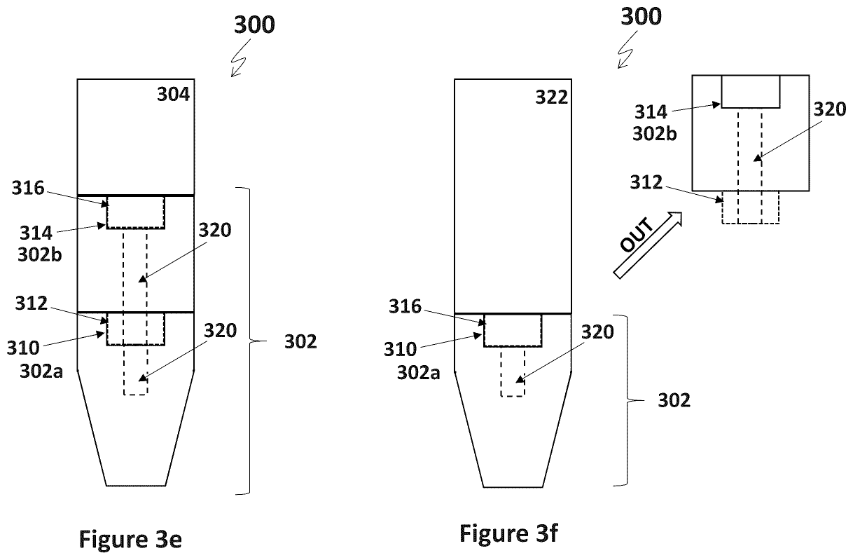

Referring now to FIGS. 3a-d, showing schematic representations of an exemplary dental implant assembly 300, according to some embodiments of the invention. In some embodiments, an exemplary dental implant assembly 300 is similar and/or comprises similar features to that shown in FIGS. 2a-i, with the differences that will be further explained below.

Referring now to FIG. 3a, showing a schematic representation of exemplary parts of an exemplary dental implant assembly 300, according to some embodiments of the invention. In some embodiments, an exemplary dental implant assembly 300 comprises a dental implant 302, the implant 302 comprising two or more parts or portions 302a/302b. The terms “parts” and “portions” are interchangeable in their meaning when referring to the upper/lower parts or upper/lower portions.

In this example, an exemplary dental implant assembly 300 comprises a lower part 302a and an upper part 302b. In some embodiments, optionally, the exemplary dental implant assembly 300 is connected to an abutment 304 onto which a crown 306 can be mounted. In the following paragraphs, explanations of the exemplary dental implant assembly will be disclosed with an abutment, it should be understood that the abutment is not part of the dental implant assembly and that the use of an abutment in the explanations is provided to allow a person having skills in the art to understand the invention and the potential advantages thereof.

In some embodiments, similar to what was disclosed above, a rod 308 is used to reversibly connect between the parts of the dental implant assembly 300, for example between the two or more parts 302a/302b and the abutment 304. In some embodiments, an exemplary dental implant assembly 300 comprises a lower part 302a and preferably only one upper part 302b. In some embodiments, an exemplary dental implant assembly 300 comprises a lower part 302a and more than one upper part 302b, for example two, three four or five upper parts.

Referring now to FIG. 3b, showing a schematic exploded view representation of exemplary parts of an exemplary dental implant assembly 300, according to some embodiments of the invention.

In some embodiments, as mentioned above, the implant 302 comprises two or more parts 302a/302b.

In some embodiments, the lower part 302a of the implant 302 comprises a female connector 310 on a proximal end of the lower part 302a.

In some embodiments, the upper part 302b of the implant comprises both a male connector 312 on a distal end of the upper part 302b, configured to be connected with the female connector 310 of the lower part 302a, and a female connector 314 on a proximal end of the upper part 302a.

In some embodiments, an exemplary abutment 304 having a male connector 316 is configured to be connected with the female connector 314 of the upper part 302b.

In some embodiments, the crown 306 comprises an area 318 configured to match the geometry of the abutment 304.

In some embodiments, a user mounts the upper part 302b on top of the lower part 302a and then the abutment 304 on top of the upper part 302b and attach them together by inserting the rod 304 in the dedicated internal channel 320 located in both the lower part 302a and the upper part 302b, and optionally in the abutment 304.

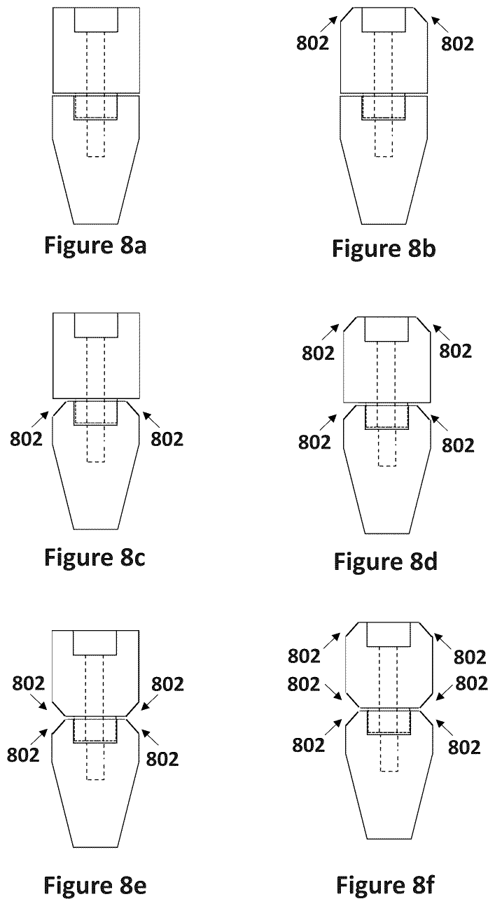

In some embodiments, the implant 302, comprising the two or more parts 302a/302b, comprises the features of known dental implants in the art, for example, the body comprises a distal end having conical form having the thinnest part at the most distal end of the dental implant and extending to the most widest part at the most proximal end of the dental implant; and the body comprises a threaded portion along the length of the body. In some embodiments, optionally each part or portion (302a/302b) of the dental implant comprises a switching platform feature at a most proximal end of each part or portion. In some embodiments, a “switching platform” is a feature that comprises a reduction in the circumference of the most proximal top area of a dental implant. FIGS. 8a-f schematically show an exemplary dental implant assembly having a switching platform feature in one or more or all the parts or portions of the dental implant assembly. FIG. 8a shows an exemplary dental implant assembly without a switching platform feature. FIG. 8b shows an exemplary dental implant assembly where only the upper part comprises a switching platform feature 802. FIG. 8c shows an exemplary dental implant assembly where only the lower part comprises a switching platform feature 802. FIG. 8d shows an exemplary dental implant assembly where the lower part and the upper part comprise a switching platform feature 802. FIG. 8e shows an exemplary dental implant assembly where the lower part comprises a switching platform feature 802 and the upper part comprises a switching platform feature 802 at the distal end of the upper part. FIG. 8f shows an exemplary dental implant assembly where the lower part and the upper part comprise a switching platform feature 802 and additionally the upper part comprises a switching platform feature 802 at the distal end of the upper part. In some embodiments, a potential advantage of having a switching platform feature 802 is that it allows bone to grow within the area of the implant that is smaller which potentially increases the stability of the dental implant in the bone.

In some embodiments, the lower part 302a is configured to be used as a regular dental implant just shorter in length. For example, if the whole implant 302 (which comprises two or more parts) is the definition of a regular implant, then the lower part 302a of the implant 302 alone is a “shorter” version of a regular implant, while the upper part 302b (or any other number of parts added to the lower part), are extensions of the body of the “shorter version” dental implant. It should be emphasized that functionally wise, the lower part 302a functions and/or is configured to function as a regular dental implant, so in principle, the lower part 302a could be implanted a priori by itself, without the need to use the one or more upper parts 302b. In some embodiments, as mentioned above, the lower part 302a comprises a body having distal end that is conical, which a known feature in dental implants, and a proximal end having a cylindrical form, also a known feature in dental implants. In some embodiments, the one or more upper parts comprise a body having a similar cylindrical form as the lower part, thereby, when the lower part is connected to one or more upper parts, de facto, the dental implant grows in length.

Referring now to FIGS. 3c-d, showing schematic representations of exemplary dental implant assembly 300 in different configurations, according to some embodiments of the invention. FIG. 3c, shows the parts as shown in FIG. 3b but in an assembled configuration and showing the distinct connectors between the parts. In some embodiments, as stated above, the upper part(s) 302b can be removed from the lower part 302a, leaving the lower part 302a as the actual dental implant 302, as schematically shown in FIG. 3d. In some embodiments, in order to allow the connection between the lower part 302a and the abutment 304, the geometry/form of the male connector 316 of the abutment 304 and the geometry/form of the female connector 310 of the lower part 302a must be compatible. Therefore, in some embodiments, the geometry/form of the female connector 310 of the lower part 302a is identical (or at least geometrically similar/compatible) to the geometry/form of the female connector 314 of the upper part 302b; and the geometry/form of the male connector 312 of the upper part 302b is identical (or at least geometrically similar/compatible) to geometry/form of the male connector 316 of the abutment 304. In some embodiments, a potential advantage of having identical (or at least geometrically similar/compatible) geometries/forms of the connectors between the different parts of the exemplary dental assembly is that it allows to change the length of the dental implant without the need to change the abutment and/or crown.

Referring now to FIGS. 3e-f, showing schematic representations of exemplary dental implant assembly 300 in different configurations, according to some embodiments of the invention. FIG. 3e, shows the parts as shown in FIG. 3b but in an assembled configuration and showing the distinct connectors between the parts. In some embodiments, as stated above, the upper part(s) 302b can be removed from the lower part 302a, leaving the lower part 302a as the actual dental implant 302, as schematically shown in FIG. 3f. In some embodiments, a new abutment 322 is connected to the lower part 302a. In some embodiments, in order to allow the connection between the lower part 302a and the new abutment 322, the geometry/form of the male connector 316 of the new abutment 322 and the geometry/form of the female connector 310 of the lower part 302a must be compatible. Therefore, in some embodiments, the geometry/form of the female connector 310 of the lower part 302a is identical (or at least geometrically similar/compatible) to the geometry/form of the female connector 314 of the upper part 302b; and the geometry/form of the male connector 312 of the upper part 302b is identical (or at least geometrically similar/compatible) to geometry/form of the male connector 316 of the new abutment 322. In some embodiments, a potential advantage of having identical (or at least geometrically similar/compatible) geometries/forms of the connectors between the different parts of the exemplary dental assembly is that it allows to change the length of the dental implant without the need to change the abutment and/or crown. In some embodiments, the new abutment 322 comprises a length that is equal to the sum of lengths of the upper part 302b and the previously connected abutment 304. In some embodiments, a potential advantage of replacing the abutment 304 with a longer new abutment 322 is that it allow the removal of the upper parts of the dental implant to eliminate peri-implantitis while keeping the height of the crown as it was previously done.

In some embodiments, the connectors disclosed above can be connectors typically used in the area of dental implants, for example hexagonal connectors having female/male counterparts in the different dental parts.

In some embodiments, a total length of an exemplary dental implant 300 is from about 6 mm to about 16 mm, optionally from about 5.5 mm to about 18 mm, optionally from about 4 mm to 20 mm. In some embodiments, a diameter of an exemplary dental implant 300 is from about 3.3 mm to about 5 mm, optionally from about 3 mm to about 8 mm, optionally from about 2 mm to 10 mm. In some embodiments, a length of lower part 302a is from about 6 mm to about 8 mm, optionally from about 5.5 mm to about 6.5 mm, optionally from about 5 mm to about 7 mm, while the upper is comprises the rest of the total length of the dental implant.

In some embodiments, a length of upper part 302b is from about 5 mm to about 10 mm, optionally from about 4.5 mm to about 12 mm, optionally from about 4 mm to about 14 mm, while the lower is comprises the rest of the total length of the dental implant.

### Exemplary Method of Eliminating Peri-Implantitis

In the following paragraphs a method of eliminating peri-implantitis will be explained. The term “eliminating peri-implantitis” is related to the medical definition of the decease, in which removing the part of the dental implant actually eliminates the source of the decease. It should be understood that the method could include other actions performed by the dedicated personnel performing the removal of the part of the dental implant, for example, routine actions like removing granulation tissue (if any is found in the area where the upper part of the implant has been removed). It should be also mentioned that “removal of granulation tissue” is not an action of reconstruction or regeneration of the tissues, which are considered as medical procedures. Additionally, intrinsic healing processes, which naturally occur due to the removal of an infected part of the dental implant, while they do happen, they are not part of the below-mentioned method.

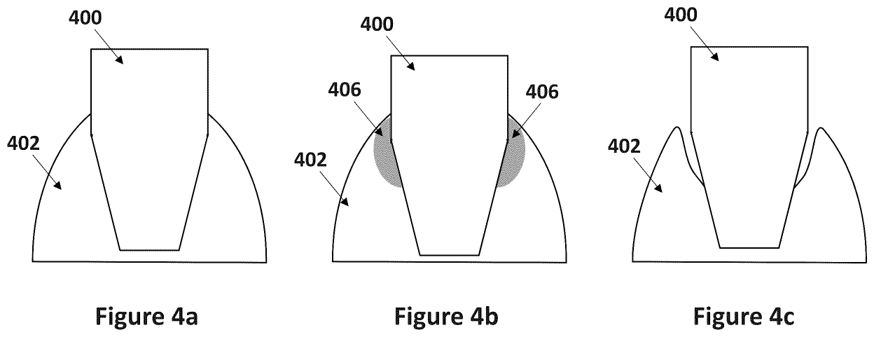

As mentioned above, peri-implantitis typically happens when the upper parts of a dental implant get contaminated, for example by bacteria, therefore damaging the gums and the bone holding the dental implant. FIGS. 4a-c shows a schematic representation of this process. In FIG. 4a, a dental implant 400 has been implanted in the bone 402. In FIG. 4b, peri-implantitis 404 developed in the site of implantation. In FIG. 4c, there is severe bone recession 406 due to the peri-implantitis.

It is a scope of the present invention to provide a method of eliminating the cause of peri-implantitis by removing contaminated parts of the dental implant that allow the presence of bacteria damaging the bone.

In some embodiments, elimination of peri-implantitis comprises shortening the dental implant by removing one or more upper parts of the dental implant, which are the contaminated parts.

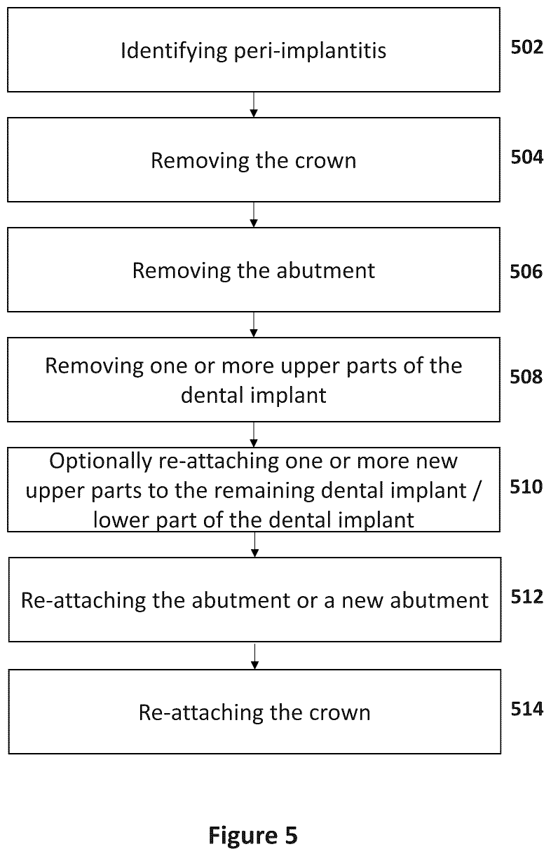

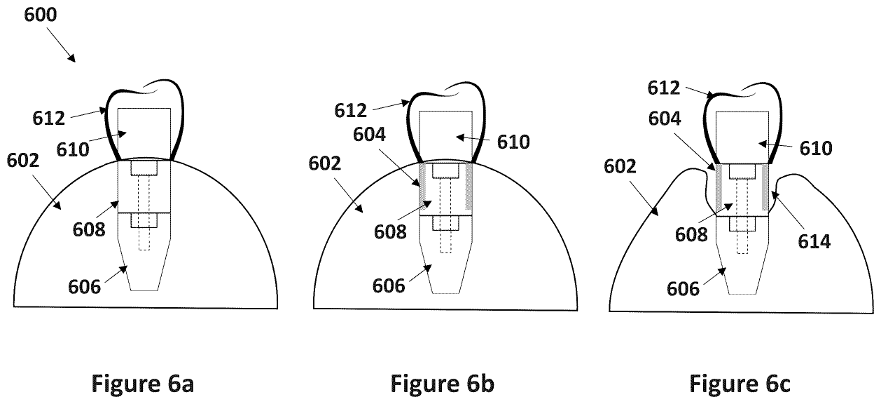

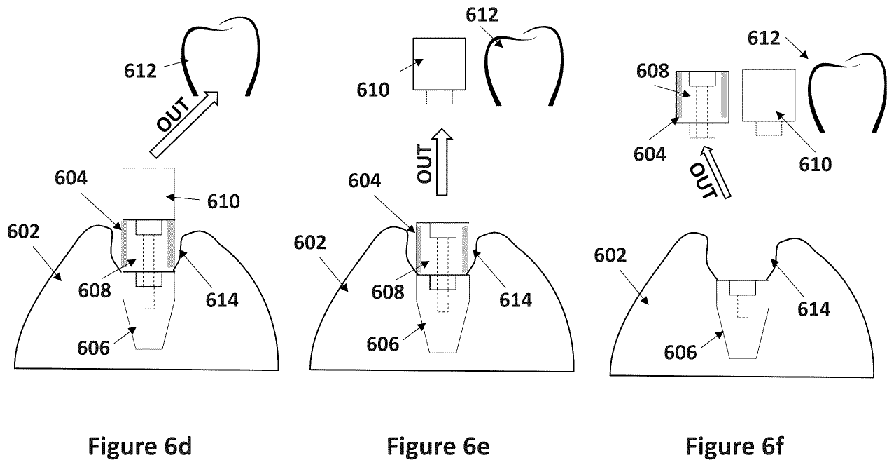

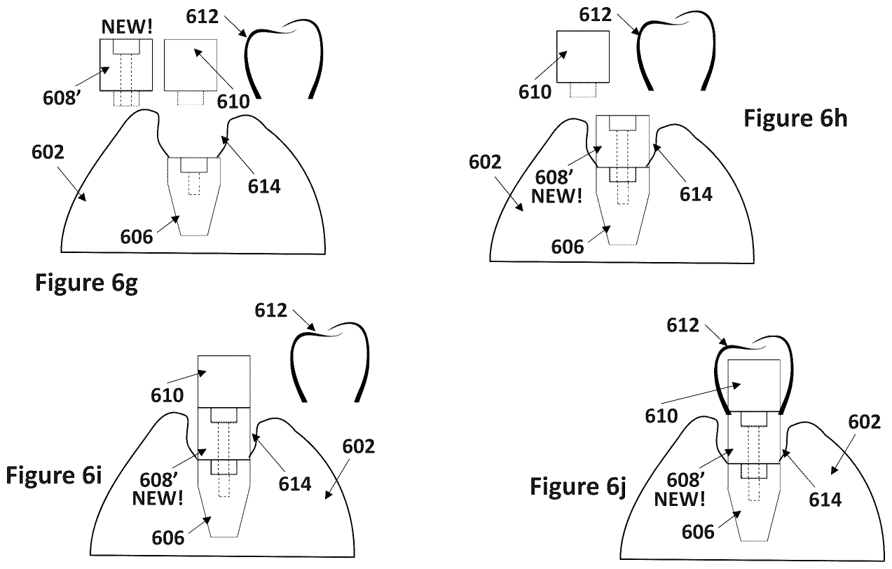

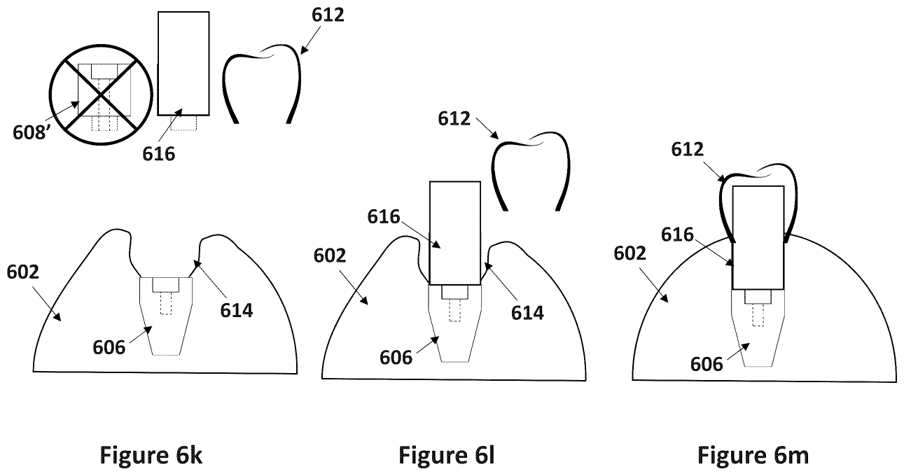

Referring now to FIG. 5, showing a flowchart of an exemplary method of eliminating peri-implantitis, according to some embodiments of the invention, and also to FIGS. 6a-m, showing schematic representations of the exemplary methods, according to some embodiments of the invention.

In a dedicated scientific article “Peri-implantitis Update: Risk Indicators, Diagnosis, and Treatment” by Rokaya D. et al, the National Institute of Health (NIH) has defined peri-implantitis as following: “Peri-implantitis is an inflammation of the peri-implant mucosa accompanied by marginal bone loss” that is caused by Gram-negative anaerobic bacteria growing in the areas where a dental implant has been implanted and on the surfaces of the dental implant due to the presence of gaps in the external surface of the dental implants, and in gaps between adjacent dental parts (dental implant and abutment for example). Additionally, upper parts of dental implants are more prone to develop peri-implantitis due to their proximity to the open surfaces of the mouth.

In some embodiments, a potential advantage of the method is that is a method of eliminating peri-implantitis, and not actually treating peri-implantitis. In some embodiments, the method does not involve a treatment action, just removing a part (or more parts) of the implant, which automatically eliminates peri-implantitis. In some embodiments, the method comprise the removal of the upper parts of the implant where the bacteria causing the inflammation are located.

In some embodiments, the method comprises identifying the presence of peri-implantitis 502. In some embodiments, identifying the presence of peri-implantitis comprises identifying the presence of bacteria on at least a part of the external surface of the dental implant. In some embodiments, identifying the presence of peri-implantitis comprises identifying the presence of one or more of gum pockets deepen and/or gums recede from the implant and/or bone receding from the dental implant; pus pockets form or ooze from the gums around the dental implant; bleeding and irritation at the gum-line with or without brushing; plaque buildup along the gums and/or gums are red and swollen; progressive loss of supporting bone as seen on repeat x-rays; and/or the metal thread of the implant support post is exposed and visible. FIG. 6a shows an implant assembly 600 as found in the bone 602 when there is no peri-implantitis 604 (gray area in the implant as seen for example in FIG. 6b). The implant assembly 600 comprises a lower part 606, an upper part 608, an abutment 610 and a crown 612. The connecting rod is not shown in FIGS. 6a-m. FIG. 6b shows schematically peri-implantitis 604 in the upper parts of the implant, as grey areas in the upper part 608 of the implant. FIG. 6c shows schematically the due to peri-implantitis the bone of the jaw shows a recession 614, between the dental implant and the bone of the jaw.

In some embodiments, the method comprises removing the crown 504, as schematically shown in FIG. 6d.

In some embodiments, the method comprises removing the abutment 506, as schematically shown in FIG. 6e.

In some embodiments, the method comprises removing one or more upper parts of the dental implant 508, as schematically shown in FIG. 6f. In some embodiments, removing one or more upper parts of the dental implant comprises removing the upper parts that were found in the peri-implantitis area and/or removing the upper parts where bacteria (or any other cause of peri-implantitis) was found.

In some embodiments, removing the abutment and/or removing one or more upper parts of the dental implant comprises removing the rod connecting between the parts (not shown in FIG. 6a-m).

In some embodiments, optionally, a dedicated personnel may choose to perform a removal of granulation tissue, if any is found. While this is action is mentioned here, it is important to emphasize that is an optional action.

In some embodiments, the method comprises optionally re-attaching one or more new upper parts 510 to the remaining part of the dental implant (the lower part), as schematically shown in FIG. 6g and FIG. 6h. In some embodiments, if the recession of the bone is not severe and there is still bone left in the area where the one or more upper parts have been removed, optionally, new upper parts can be added/attached instead of the ones that have been removed, as schematically shown in FIGS. 6i and 6j. In some embodiments, if the recession of the bone is too severe and/or there not enough bone in the area where the one or more upper parts where removed, then no new upper parts will be added, as schematically shown in FIGS. 6k, 6l and 6m.

In some embodiments, the method comprises re-attaching the abutment 610 or attaching a new abutment 616 (512), as schematically shown in FIG. 6k, FIG. 6l and FIG. 6m. In some embodiments, as stated above, the lower parts of the dental implant comprise a female connector configured to receive a male connector of the abutment (either the previous one 610 or a new one 616), in the same manner as the recently removed upper parts received the abutment.

In some embodiments, re-attaching the abutment 610 and/or attaching new one 616 or more upper parts of the dental implant comprises reinserting the rod connecting between the parts. In some embodiments, in the case where one or more parts have been removed and not replaced, a shorter rod is used.

In some embodiments, re-attaching the abutment comprises attaching a new abutment 616 that is more fit to the situation in the jaw, for example a new abutment 616 that brings the crown to the height as it was previously found before the removal of the upper parts, as schematically shown in FIGS. 6k, 6l and 6m.

In some embodiments, the method comprises re-attaching the crown to the abutment 514, as schematically shown in FIG. 6j and FIG. 6m.

### Exemplary Potential Advantage of the Use of the Dental Implant Assembly in Dental Bridges

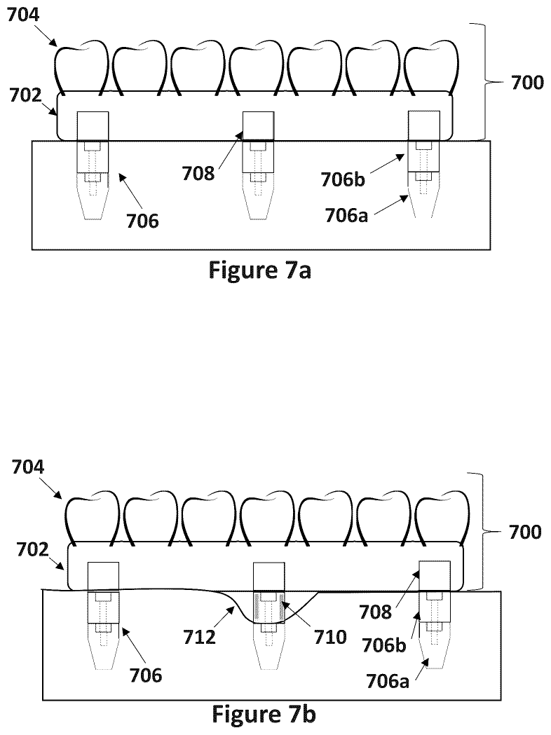

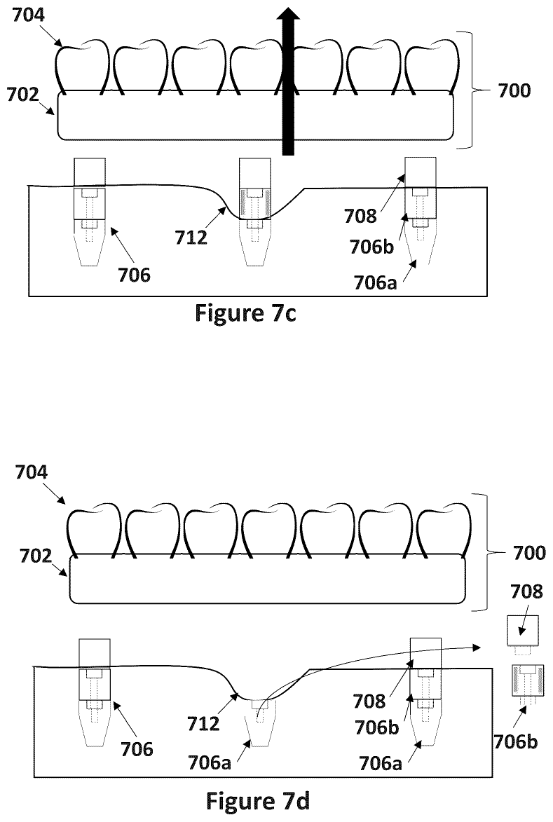

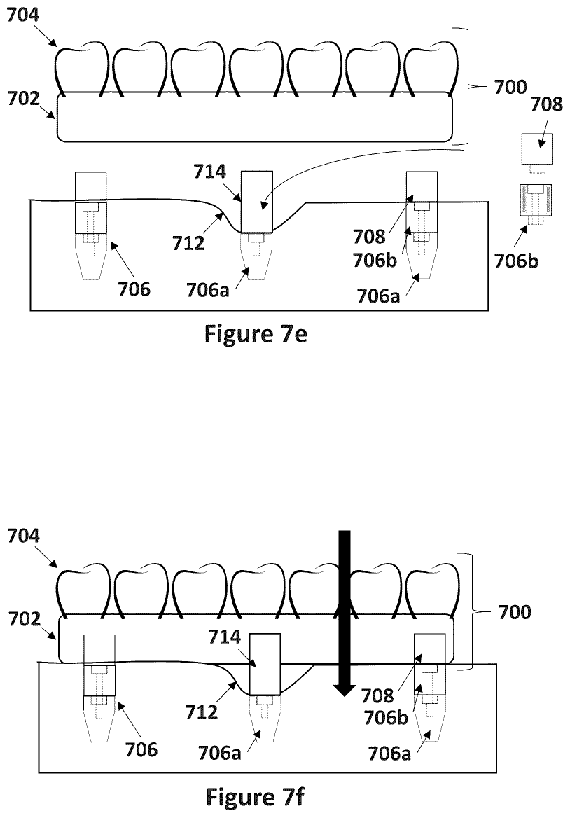

Referring now to FIGS. 7a-7f, showing a schematic representation of the use of multiple dental implant assemblies in dental bridges, according to some embodiments of the invention.

In some embodiments, when more than one adjacent teeth are missing, dental bridges 700 can be used. Usually, a dental bridge 700 comprises a base 702 to which one or more teeth 704 are connected. In some embodiments, the base 702 is then connected to one or more dental implants 706 using abutments 708, as schematically shown in FIG. 7a.

In cases where peri-implantitis 710 develops, as schematically shown in FIG. 7b, in a dental bridge situation, the loose of bone 712 can cause instability to one or more dental implants 706, which can be catastrophic to the stability of the dental bridge 700.

In some embodiments, a potential advantage of the exemplary dental implant assembly is that it allows to eliminate the peri-implantitis 710 while keeping at least a part of the dental implant.

In some embodiments, as mentioned above, an exemplary dental implant 706 comprises a bottom part 706a and one or more upper parts 706b.

In some embodiments, in the case where peri-implantitis is found in a dental bridge situation, the dental bridge 700 is removed (as schematically shown in FIG. 7c). In some embodiments, then, the abutment 708 and the upper part 706b of the dental implant causing peri-implantitis are removed, as schematically shown in FIG. 7d. In some embodiments, a new abutment 714 is inserted, as schematically shown in FIG. 7e. In some embodiments, the new abutment 714 is configured in length to compensate for the “lost height” caused by the removal of the upper part, for example, the new abutment 714 is as long as the sum of the length of the upper part 706b and the length of the previous abutment 708. This way, eliminating peri-implantitis, by removing one or more upper parts, does not force the dentist to start re-implanting dental implants and/or re-making dental bridges, and the previous dental bridge can be repositioned, as schematically shown in FIG. 7f.

### Exemplary Method of Speeding up Healing of Dental Bone After Identification of Peri-Implantitis

In some embodiments, once peri-implantitis has been identified, for example by visually identifying the recession of the bone around the dental implant, in order to speed up the healing process, a dedicated personnel performs the following actions:
1. Removing a crown from the dental implant to expose the abutment under it.
2. Removing the abutment to expose the dental implant under it.
3. Removing an upper part of the dental implant leaving a lower part of the dental implant.
4. Optionally, performing a removal of granulation tissue, if any is found. While this is action is mentioned here, it is important to emphasize that is an optional action.
5. Attaching a new part to the lower part, where a new part can be:
   a. a new upper part (as explained above);
   b. a new abutment being longer in size (a total length of the length of the upper part that was removed and the length of the previous abutment that was connected to the dental implant).
6. Reattaching the crown.

In some embodiments, removing and attaching actions involve the removal or the insertion of the rod connecting between the parts.

In some embodiments, performing the actions above speed up the healing process by removing the cause of the decease, which is, for example, an infected upper part of the dental implant.

### Exemplary Method of “Treating” Peri-Implantitis

In some embodiments, while no direct treatment on the infected tissue is performed, the actions of removing an infected part of the dental implant causing the peri-implantitis, might be seen as “treating” peri-implantitis. Therefore, in some embodiments, the following actions are performed to “treat” peri-implantitis.

In some embodiments, once peri-implantitis has been identified, for example by visually identifying the recession of the bone around the dental implant, in order to “treat” peri-implantitis, a dedicated personnel performs the following actions:
1. Removing a crown from the dental implant to expose the abutment under it.
2. Removing the abutment to expose the dental implant under it.
3. Removing an upper part of the dental implant leaving a lower part of the dental implant.
4. Optionally, performing a removal of granulation tissue, if any is found. While this is action is mentioned here, it is important to emphasize that is an optional action.
5. Attaching a new part to the lower part, where a new part can be:
   a. a new upper part (as explained above);
   b. a new abutment being longer in size (a total length of the length of the upper part that was removed and the length of the previous abutment that was connected to the dental implant).
6. Reattaching the crown.

In some embodiments, removing and attaching actions involve the removal or the insertion of the rod connecting between the parts.

In some embodiments, performing the actions above “treat” peri-implantitis by removing the cause of the decease, which is, for example, an infected upper part of the dental implant.

As used herein with reference to quantity or value, the term “about” means “within ±20% of”.

The terms “comprises”, “comprising”, “includes”, “including”, “has”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular forms “a”, “an” and “the” include plural references unless the context clearly dictates otherwise. For example, the term “a compound” or “at least one compound” may include a plurality of compounds, including mixtures thereof.

Throughout this application, embodiments of this invention may be presented with reference to a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as “from 1 to 6” should be considered to have specifically disclosed subranges such as “from 1 to 3”, “from 1 to 4”, “from 1 to 5”, “from 2 to 4”, “from 2 to 6”, “from 3 to 6”, etc.; as well as individual numbers within that range, for example, 1, 2, 3, 4, 5, and 6. This applies regardless of the breadth of the range.

Whenever a numerical range is indicated herein (for example “10-15”, “10 to 15”, or any pair of numbers linked by these another such range indication), it is meant to include any number (fractional or integral) within the indicated range limits, including the range limits, unless the context clearly dictates otherwise. The phrases “range/ranging/ranges between” a first indicate number and a second indicate number and “range/ranging/ranges from” a first indicate number “to”, “up to”, “until” or “through” (or another such range-indicating term) a second indicate number are used herein interchangeably and are meant to include the first and second indicated numbers and all the fractional and integral numbers therebetween.

Unless otherwise indicated, numbers used herein and any number ranges based thereon are approximations within the accuracy of reasonable measurement and rounding errors as understood by persons skilled in the art.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A dental implant for the elimination of peri-implantitis, comprising a body comprising a proximal end and a distal end, said body comprising:
a. a lower portion located at said distal end of said body; said lower portion comprising a first first type of connector at a proximal end of said lower portion; said lower portion comprising a first internal channel partially extending distally from said proximal end; and
b. one or more upper portions located at said proximal end of said body; each upper portion of said one or more upper portions comprising:
i. a first second type of connector located at a distal end of said upper portion and configured to connect with said first first type of connector; and
ii. a second first first type of connector located a proximal end of said upper portion; and
iii. a second internal channel extending along the whole length of each of said one or more upper portions;
wherein said first first type of connector is geometrically similar or identical to said second first first type of connector;
wherein said second internal channel being positioned to generate a continuous channel with said first internal channel;
wherein said first first type of connector, said first second type of connector and said second first first type of connector are not threaded connectors.

2. The dental implant according to claim 1, wherein said dental implant comprises only one upper part.

3. The dental implant according to claim 1, wherein said first first type of connector is a female type connector.

4. The dental implant according to claim 1, wherein said second type of connector is a male type connector.

5. The dental implant according to claim 1, wherein said first first type of connector and said second first type of connector are both configured to be coupled to an abutment.

6. The dental implant according to claim 5, wherein said abutment comprises a second type of connector that is configured to be coupled to said first first type of connector and said second first type of connector.

7. The dental implant according to claim 1, wherein said body comprises an internal channel configured to receive a securing rod; said securing rod configured to secure said lower portion and said one or more upper portions.

8. The dental implant according to claim 1, wherein said body comprises a threaded portion extending from said distal end to said proximal end.

9. The dental implant according to claim 1, wherein said lower portion comprises a distal end having a conical or narrowing form and a proximal end having a cylindrical continuous form; and
wherein said one or more upper parts have a same cylindrical continuous form as said proximal end of said lower portion;
wherein when said lower portion is connected to one upper part of said one or more upper parts it generates a continuous surface having said cylindrical continuous form.

10-11. (canceled)

12. The dental implant according to claim 1, wherein said lower portion comprises a switching platform feature at a most proximal end of said lower portion; and wherein when said lower portion is connected to one upper part of said one or more upper parts it comprises an indentation at the area where said lower portion and said one or more upper parts meet; said indentation generated by said switching platform feature.

13. The dental implant according to claim 1, wherein each of said one or more upper portions comprise a switching platform feature at a most proximal end of said one or more upper portions.

14. (canceled)

15. The dental implant according to claim 1, wherein said lower portion is a shorter version of said dental implant.

16-19. (canceled)

20. The dental implant according to claim 1, further comprising a rod configured to be inserted within said first internal channel of said lower portion and said second internal channel of each of said one or more upper portions, and reversibly connect between said lower portion and said one or more upper portions.

21. A method of eliminating peri-implantitis in a location where a dental implant is located, the dental implant comprising:
a body comprising a proximal end and a distal end, said body comprising:
a. a lower portion located at said distal end of said body; said lower portion comprising a first first type of connector at a proximal end of said lower portion; said lower portion comprising a first internal channel partially extending distally from said proximal end; and
b. one or more upper portions located at said proximal end of said body; each upper portion of said one or more upper portions comprising:
i. a first second type of connector located at a distal end of said upper portion and configured to connect with said first first type of connector; and
ii. a second first type of connector located a proximal end of said upper portion; and
iii. a second internal channel extending along the whole length of each of said one or more upper portions;
wherein said first first type of connector is geometrically similar or identical to said second first type of connector;
wherein said second internal channel being positioned to generate a continuous channel with said first internal channel;
wherein said first first type of connector, said first second type of connector and said second first type of connector are not threaded connectors.
the method comprising:
a. identifying the presence of peri-implantitis;
b. removing an upper part of said implant.

22. The method according to claim 21, wherein said identifying comprises identifying loss of bone around an area where said upper part of said dental implant is located.

23. The method according to claim 21, further comprising removing an abutment from said upper part of said implant before said removing said upper part of said implant.

24. The method according to claim 23, further comprising removing a crown from said abutment before said removing said abutment.

25. The method according to claim 23, further comprising one or more of:
a. reconnecting said abutment to a lower part of said implant;
b. reconnecting a crown to said abutment after said reconnecting said abutment; and
c. connecting a new upper portion to said implant before reconnecting said abutment.

26-27. (canceled)

28. The method according to claim 21, further comprising connecting a new abutment to said implant; said new abutment having a total length consisting of the sum of a length of said removed upper part of said implant and a length of said removed abutment.

29-47. (canceled)
